(19) United States
(12) Patent Application Publication
(10) Pub. No.: US 2010/0177911 A1
(43) Pub. Date: Jul. 15, 2010

(54) Method of constructing a multiway loudspeaker system with improved phase response to pass a square wave

(76) Inventor: Ryuji Yonemoto, San Mateo, CA (US)

Correspondence Address: Ryuji Yonemoto, 34277 Duffy Terrace, Fremont, CA, 94555, US

(21) Appl. No.: 12/321,017

(22) Filed: Jan. 15, 2009

(51) Int. Cl. H04R 1/40

(52) U.S. Cl. 381/97

(57) ABSTRACT

A multi-way loudspeaker system comprising of frequency equalization circuit, a linear phase dividing network, with optional phase shifters to enable the loudspeaker to have substantially improved frequency and phase response characteristics but not limited thereto is discussed. The loudspeaker exhibits high accuracy not only in amplitude but also in time domain characteristics which results in an improved transmission characteristics of time sensitive signals such as square waves.

### BACKGROUND OF THE INVENTION

The field of the invention pertains to multi-way loudspeaker systems. In particular, the invention pertains to a multi-way loudspeaker system that preserves the overall integrity of both frequency and time domain response such that the sum of the outputs of the loudspeaker will closely preserve the amplitude and phase response of the input signal, such that the system will allow square wave to pass through without significant distortion.

Such system has been implemented in the past by means of adding a third loudspeaker at the crossover frequencies of the loudspeakers to reintroduce the missing frequency and phase component of the system, but such system is costly and difficult to produce due to the necessity of adding these additional loudspeakers to the design.

In this invention, a method for constructing a multi-way loudspeaker system which does not require additional loudspeakers to correct for frequency and phase correction and closely preserves the amplitude and the phase response of the input signal such that square wave can pass through without significant distortion will be disclosed.

### SUMMARY OF THE INVENTION

The present invention relates to a system and method for a multi-way loudspeaker system where sum of its outputs closely maintains overall flat frequency response, and linear phase characteristics such that phase sensitive signals such as square wave can pass through the loudspeaker with improved accuracy. In a particular embodiment, incoming signal first goes into a frequency and phase compensating circuit. The output of this frequency and phase compensating circuit is introduced into a zero phase or constant delay dividing network which generates the frequency components that will be introduced into the individual loudspeaker. These signals may further be frequency and phase equalized to correct for the frequency and phase incorrectness of the loudspeakers themselves. This results in a system where the sum of the outputs of each loudspeaker closely resembles flat frequency, and improved phase response relative to the input such that a phase sensitive signal such as square wave can pass through without significant distortion. The loudspeaker's ability to pass a square wave will be used in this case as a benchmark for successful design of such system.

### BRIEF DESCRIPTION OF THE DRAWINGS

FIG. 1 illustrates the general circuit configuration of a conventional 2 way loudspeaker system.

FIG. 2 illustrates the frequency response of the circuit of FIG. 1 implemented with a first order dividing network with loudspeakers modeled as an ideal second order low pass and high pass filter.

FIG. 3 illustrates the frequency response of the same circuit of FIG. 2 with high frequency loudspeaker connected in reverse phase.

FIG. 4 illustrates the time domain response of the dividing network of FIG. 2 using 1 kHz square wave response.

FIG. 5 illustrates circuit implementation of inserting a frequency and phase compensating circuit between the input and the dividing network of FIG. 1.

FIG. 6 shows the frequency and phase response of the frequency and phase compensating circuit which was inserted in FIG. 5.

FIG. 7 shows the frequency and phase response of the circuit of FIG. 5 showing the effect of frequency compensating circuit.

FIG. 8 is the 1 kHz square wave response of the circuit of FIG. 7.

FIG. 9 shows the circuit of FIG. 5 with additional frequency and phase compensating circuit inserted between the outputs of the dividing network and the loudspeakers.

FIG. 10 shows the circuit of FIG. 5 with additional frequency and phase compensating circuit, phase shifter, and a power amplifier inserted between the output of the dividing network and the loudspeakers.

FIG. 11 shows the frequency response of a high frequency loudspeaker used in the example implementation.

FIG. 12 shows the frequency response of a low frequency loudspeaker used in the example implementation.

FIG. 13 shows the combined frequency response of the loudspeakers of FIG. 11 and FIG. 12 with first order dividing network.

FIG. 14 is the 1 kHz square wave response of the circuit of FIG. 13.

FIG. 15 is the frequency and phase response of the circuit of FIG. 13 with overall frequency and phase compensating circuit, and a phase shifter inserted to correct for the frequency and phase response of the circuit of FIG. 13.

FIG. 16 is the 1 kHz square wave response of the circuit of FIG. 15.

### DETAILED DESCRIPTION

The invention comprises electric circuit means in by a utilizing frequency and phase equalizer, a liner phase dividing network, and a conventional loudspeaker drivers to form a system where the sum of the outputs from the loudspeaker closely resembles flat frequency and linear phase response. The method of how this system is constructed and how it operates will be disclosed in this section. It is important to note that unlike pure electrical circuit, frequency response of a loudspeaker unit or a system contains many small peaks and valleys. Therefore when referring to the attempt to obtain flat frequency response, it will be referred to as substantially flat frequency, or phase response because the characteristics of the frequency anomaly contained in the loudspeaker varies from one design to another, and cannot be generalized as to permit uniform description in terms of their character.

A typical multi-way loudspeaker system comprises a frequency dividing network, and loudspeakers such as low, midrange, and high frequency loudspeakers. Such system can have substantially flat frequency response, however its phase response will not be linear phase due to the inherent nature of its architecture. This is caused mostly due to the fact that these loudspeakers do not use linear phase dividing network, a common practice of inverting the signal phase going into some of the loudspeakers within the system, lack of phase correcting circuits, and not having sufficiently flat overall frequency response. Method for correcting these design issues will be addressed in the following section.

FIG. 1 denotes the standard configuration of a conventional 2 way loudspeaker system where a signal coming into its primary input 101 is split by a frequency dividing network 102, and its respective low frequency and a high frequency output is fed to the low frequency and high frequency loudspeakers 103 and 104.

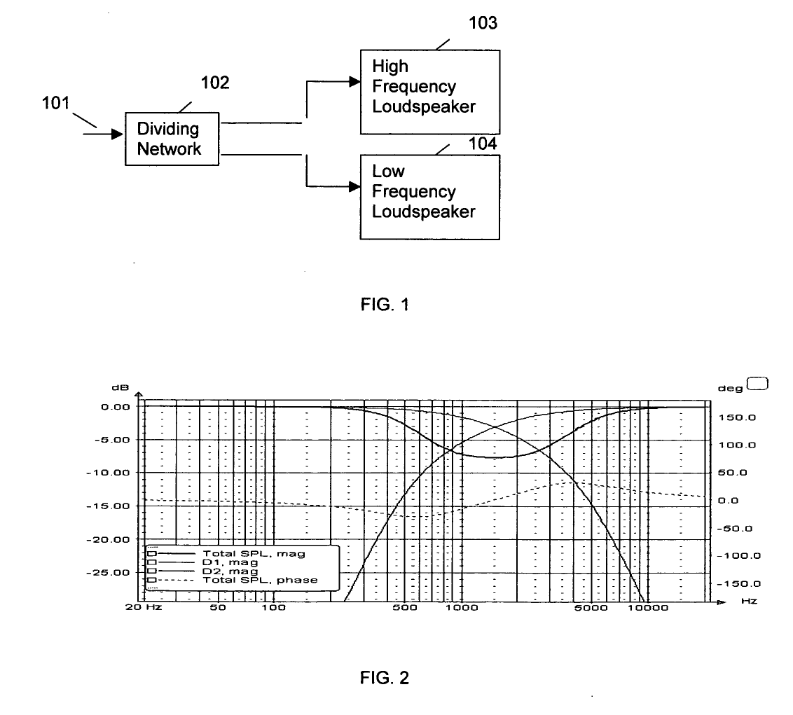

FIG. 2 shows the representative frequency response of system configured in such a way as FIG. 1. Here, a low frequency transducer is represented by a second order low pass filter which is an accurate first order representation of high frequency limiting mechanism of such loudspeaker to give generality to the discussion, and a high frequency transducer is represented by a second order high pass filter which is also an accurate first order representation of the low frequency limiting mechanism of such loudspeaker. The cutoff frequency for the low pass filter is set to 4500 Hz, and the cutoff of the high pass filter is set at 500 Hz, both filters having Q of 0.7. The crossover frequency of the dividing network is set at 1000 Hz, its order is first order, and the two loudspeakers are connected in phase to the input. As it can be seen, despite the fact that the loudspeakers have flat frequency response in their respective pass band, and the crossover having flat frequency and phase response, the resultant sum of outputs from the low and high frequency loudspeakers do not comprise a flat frequency or phase response due to the limited frequency response of the individual loudspeaker.

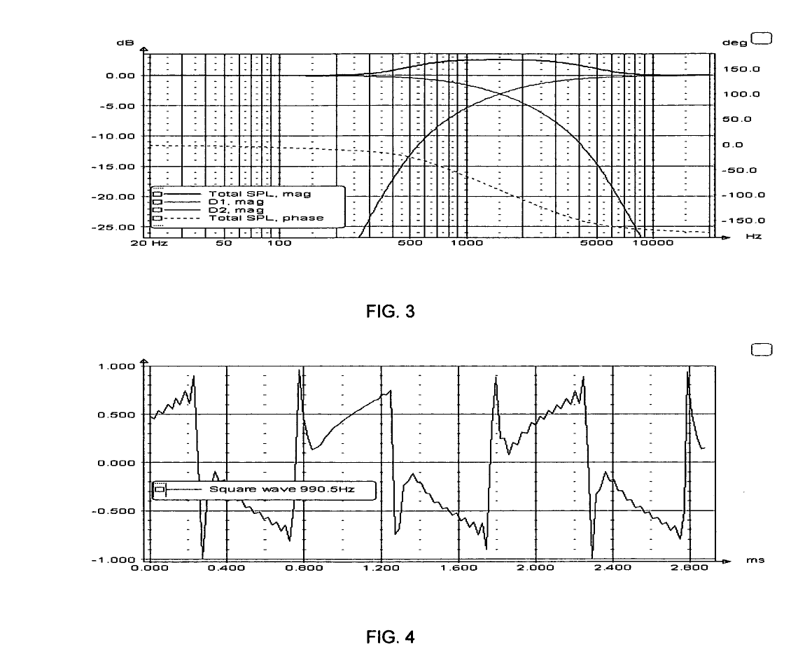

FIG. 3 shows the frequency and phase response of circuit of FIG. 1 with its high frequency loudspeaker input polarity inverted. This is the most common method seen in prior art of conventional loudspeaker design to eliminate the notch in the frequency response at the crossover frequency. The slight rise in frequency response in the crossover region is viewed as better alternative to the notch that is seen when the high frequency loudspeaker is connected in phase. However, the phase response will exhibit a gradual slope toward minus 180 degrees at higher frequencies in this configuration. In this invention, this method of correcting for the notch in the crossover region will not be used for this reason.

FIG. 4 is the square wave response of the sum of the outputs of the circuit that generated the plot of FIG. 2, which shows non-linear frequency, and phase characteristic of the overall system.

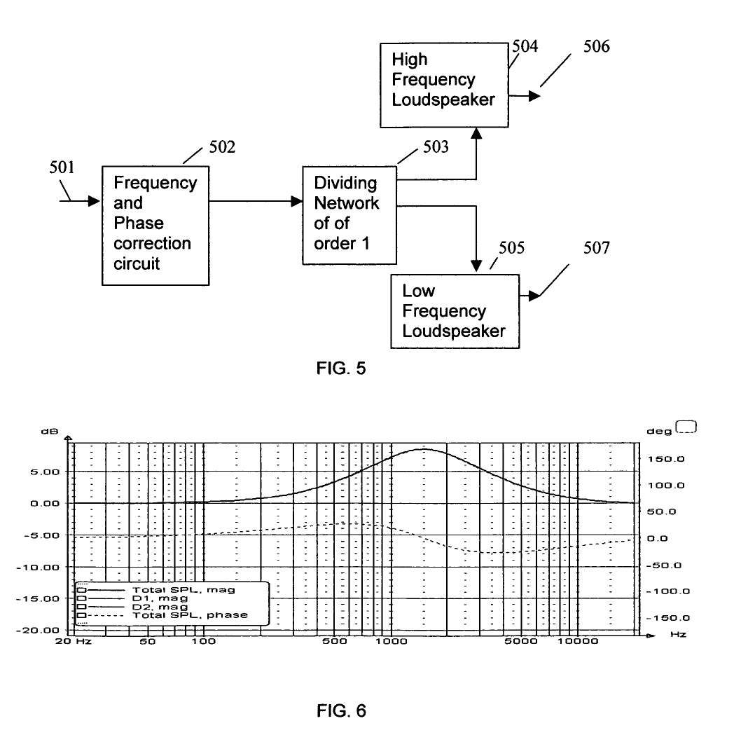

FIG. 5 shows the first embodiment of this invention where a frequency and a phase correction equalizer are inserted between the primary input of FIG. 1 101 and the crossover circuit 102. The phase response of the plot of FIG. 2 reflects the change in phase introduced by the notch in frequency response near the crossover frequency. By inserting a frequency compensation which compensates for the notch, both frequency response and phase response approaches flat frequency and phase response. While this method will not bring the frequency and phase response to a perfectly flat, state, by adding additional correction element in series as in FIG. 5 between the input 501 and the dividing network 503, the frequency and phase response of the system can be brought to an substantially close response to being perfectly flat in both frequency and phase response.

FIG. 6 shows the frequency and the phase response of the circuit inserted at FIG. 5 502. It is configured to correct for the notch in frequency response of the circuit of FIG. 2. It has center frequency of 1500 Hz Q of 1 and boost of 8.5 dB. Such circuit due to peaks and dips in frequencies of analog electrical and electromechanical system being comprised of second order complex function, a frequency inverse function will also have inverse phase response, and thus forms a compensation which corrects not only for the frequency but also the phase.

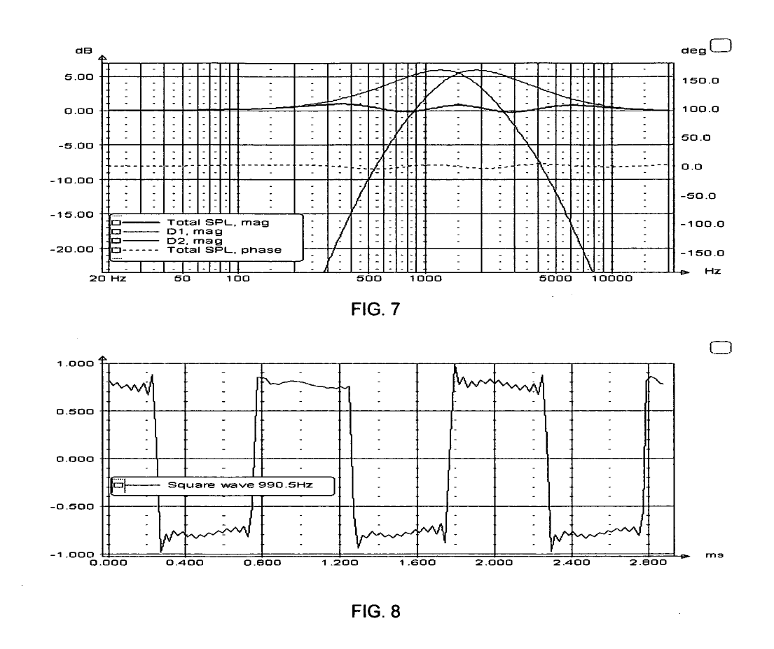

FIG. 7 shows frequency and phase response of the circuit of FIG. 5 with frequency compensation circuit with properties mentioned in FIG. 6 inserted to 502. The parameters of other parts of the circuit are identical to the circuit of FIG. 2. The phase compensation inherent in such local boost in amplitude counter acts the phase error to bring the overall phase response closer to zero degrees around the crossover region. This effect can be seen in the square wave response of the system of FIG. 8 where it shows improvement in accuracy of form over the waveform of FIG. 4.

This method of joining loudspeakers can be extended to systems comprised of more than two loudspeakers, as the dividing network can be designed for more branches in frequency division, and same method for compensation be applied at each crossover point.

Inherent Limitation of this Method

This method of frequency and phase compensation has some limitation both from theoretical and practical limitation. First the practical limitation is caused due to the fact that for about every 30 degrees of phase correction, depending on the Q of the circuit, the peak amplitude of the compensating circuit will be somewhere in the range of 8 to 10 dB in amplitude. This constitutes about 10 times the power at that frequency going into the loudspeakers. The loudspeakers must be chosen to withstand this additional influx of power. If further compensation is required, more power will be required to go into the loudspeakers. At some point, the power needed to compensate for the phase and amplitude will exceed the limit of the loudspeakers ability to accept power. An example might be, say a 90 degrees phase compensation is required for a particular design. Such a circuit will require frequency boost in the range of 24 to 30 dB. That will result in a system where when other parts of the system is experiencing 1 watt of power, the compensated region will be experiencing power ranging from 250 to 1000 watts. Clearly such system is in danger of overloading the loudspeakers with excess power and burning them out if such power is applied to their inputs. While in most case the high frequency loudspeaker have higher power to sound conversion ratio than the low frequency loudspeaker which alleviates this problem somewhat, and the low frequency loudspeaker is usually able to withstand higher input power, for most practical applications, due to this reason, the correction in frequency response should not exceed 10 to 16 dB, but situation should be reviewed individually based on the overall system configuration and the capabilities of its loudspeakers. From a theoretical point, even if the dividing network exhibits zero or linear phase response when the sums of their outputs are combined, each output of the network may have phase shifting component. It is important that combined phase shift from the dividing network's output and the phase shift of the loudspeakers themselves do not exceed 180 degrees when uncompensated. Such system will have a non-linear disjoint phase at the crossover region which is impossible to correct by linear method described above, however, inability to correct for phase characteristics due to the above mentioned power limitation will be in effect before such limit is reached.

### Preferred Characteristics of the System

The system which will allow for least amount for compensation is comprised of high frequency loudspeaker and a low frequency loudspeaker which have large overlapping frequencies preferably over 2 octaves or more in their frequency response, and for a dividing network of orders 2 and higher (higher slopes in their stop band than 12 dB/octave), a non-phase introducing crossover such as digital FIR (Finite Impulse Response) filter would reduce the difficulties of designing the system.

### Practical Considerations for Using Actual Loudspeakers

In the previous section an ideal low pass and high pass filters were used in place of actual loudspeakers to illustrate the principle of this system. Using actual loudspeaker may require further refinement of the individual loudspeaker's frequency and phase response so that they will be better suited to have flat frequency and phase response as a system. In the following section, means of achieving these characteristics will be discussed.

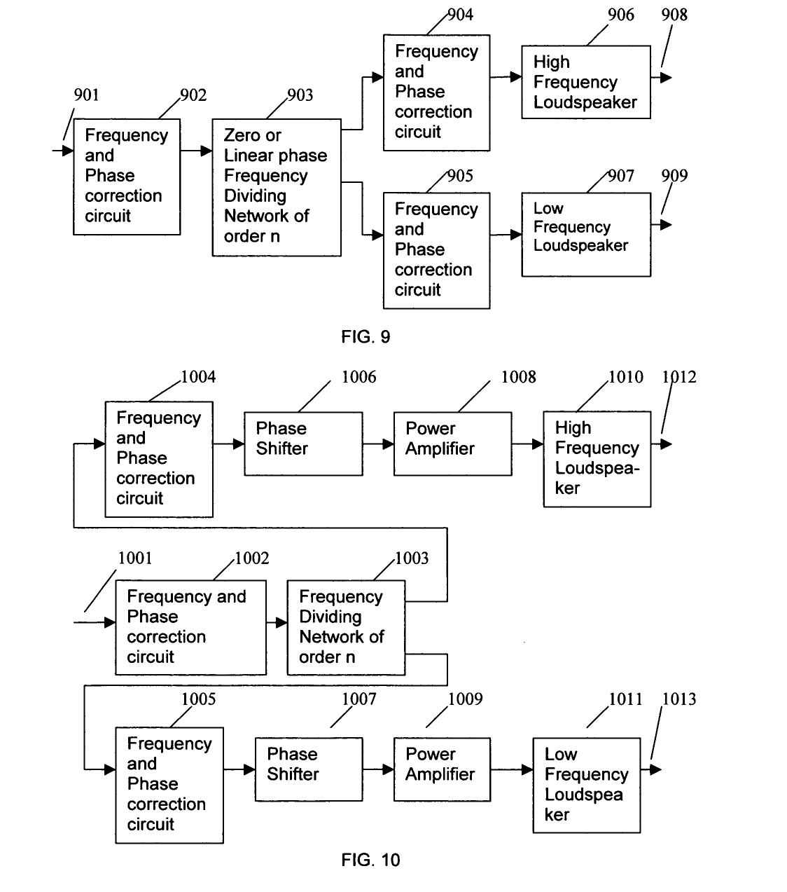

FIG. 9 shows the circuit of FIG. 5 with additional frequency compensating circuits 904 and 905 added to correct for uneven frequency response of the loudspeakers. To achieve flat frequency and phase response, each of the loudspeakers must have flat frequency and phase response in their pass bands, which is often not the case with commerciality available products. In such case, the frequency and the phase response of the individual loudspeaker requires correction by circuits inserted between the output of the frequency dividing network and the loudspeaker units. More than one such units may be needed to correct for the frequency response of the driver which in case multiple frequency correction circuits must be inserted between the frequency dividing network and the loudspeaker component.

### Adding Gain Control to Match the Output Levels of the Loudspeakers

In the case of actual loudspeaker, often the signal to sound converting efficiency varies between loudspeakers. Some means to bring their respective loudness to the same level is needed. One method is to add passive resistance to the signal path of loudspeaker that have higher signal to sound conversion efficiency. With systems with individual amplifier driving the loudspeaker, the gain of each amplifier may be adjusted so the overall loudness of the system will be consistent.

### Using Phase Shifters to Correct for Loudspeaker Phase

FIG. 10 shows phase shifters inserted before the loudspeakers to correct for the loudspeaker phase which may be inherent to the loudspeaker itself, or from the mounted location of the loudspeaker. The phase shifter may be of first order type or constant time delay type depending on the requirement. If the system has inherently good phase characteristics, such phase shifting is not necessary, but depending on the driver type and the enclosure they are mounted on, one or more phase shifting circuits can be inserted between the frequency dividing network and the loudspeaker units.

Example of an Actual System Utilizing this Method

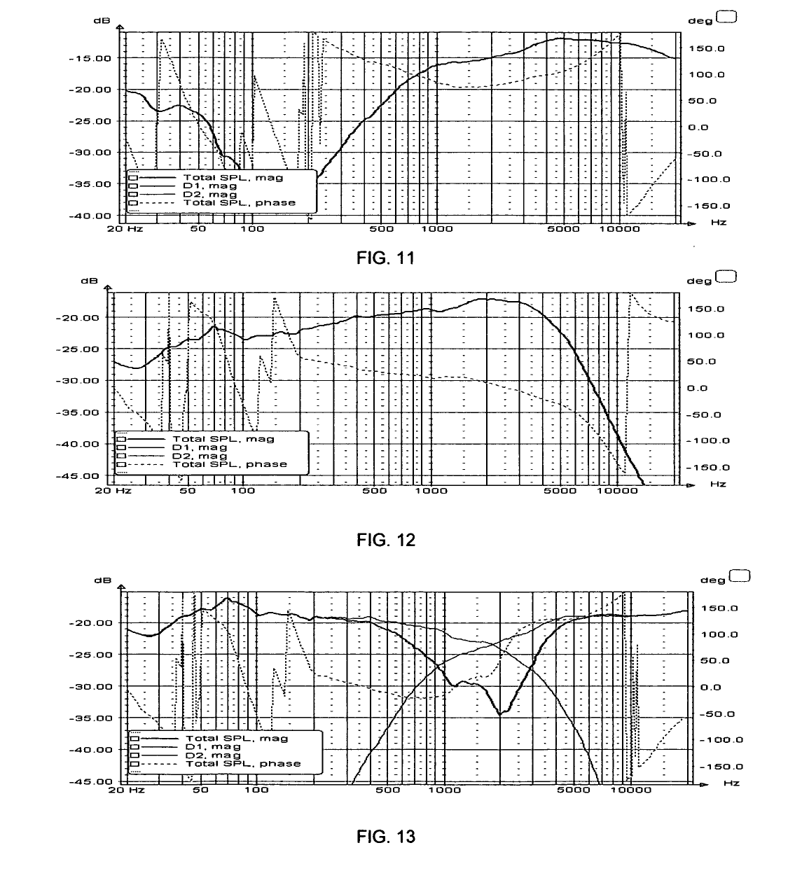

FIG. 11, and FIG. 12 shows the actual frequency response of a high frequency and a low frequency loudspeaker. FIG. 13 shows the frequency response of a loudspeaker system using the circuit configuration of FIG. 10 and loudspeakers of FIG. 11 and FIG. 12. Here, the compensation and frequency dividing network used is as follows: Frequency and phase compensating circuit of 1004 has Q of 1 and boost of +3 dB at 20 kHz. The low frequency and phase correction circuit 1005 is a first order low boost at 300 Hz with a total boost of 5 dB. Frequency dividing network of 1003 is of 1^{st} order type with crossover frequency set at 1 kHz. The actual acoustic crossover is occurring around 1800 Hz. This is acceptable as long as uncorrectable frequency or phase response is not seen in the overall response. Power amplifier 1008 has −8 dB gain relative to power amplifier 1009. It is important to note that such power amplifier must not insert significant phase shift of its own as to negate the effects of other compensating circuits. No phase shifter is inserted for this circuit. The phase variation between 200-10000 Hz exceeds 180 degrees, which will be corrected in the next section. Frequency compensating circuit 1002 is set for flat amplitude in this figure. Although the frequency compensation of the loudspeakers have been done using dedicated frequency compensation circuits 1004, and 1005, in instances where independent frequency tuning of the loudspeakers are not required, overall frequency compensation circuit 1002 can be used to correct the frequency response of the loudspeakers.

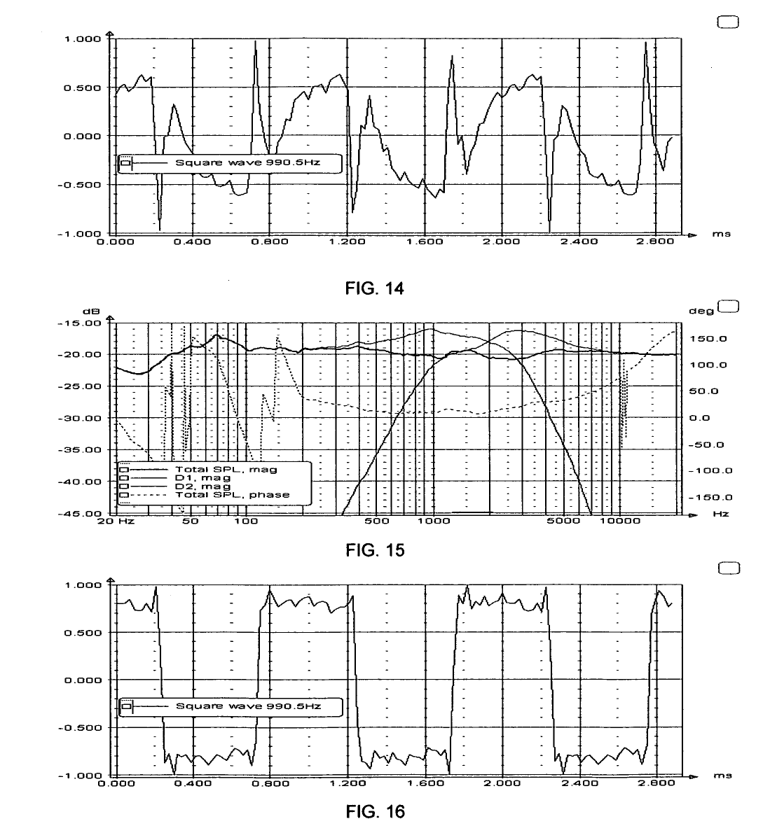

FIG. 14 shows the square wave response of the system of FIG. 13.

FIG. 15 shows the system of FIG. 13 with frequency and phase compensation circuit of 1002 set to +5 dB at 1131 Hz with Q of 1.6, and +2 dB at 2520 Hz with Q of 2.6, and +3 dB at 2828 Hz with Q of 2. Phase compensation circuit of 1006 implemented with first order all pass with a frequency of 8 kHz.

The frequency and phase response of the system of FIG. 15 shows good frequency response of staying within plus or minus 1 dB between 100 to 20 kHz, and phase response also showing significantly better response staying within 10 to 60 degrees between 200 to 10 kHz. In a conventional system, it is not unusual to see phase shift in excess of 180 degrees in this region.

FIG. 16 shows the square wave response of the system of FIG. 15. The waveform shows substantial similarity to a perfect square wave indicating the good frequency and phase response characteristics of the overall loudspeaker system.

Although the requirement varies according to the required accuracy at the output of the system, to achieve good time domain response as to be able to pass a square wave in good form, as a general rule of thumb, the overall system should have good frequency response in order of plus or minus 2 dB within the decade (factor of 10) below, and decade above the frequency of the square wave to be passed. This is not difficult to attain with the usage of multiple frequency compensating circuit used throughout the system.

Also, the range of phase within the pass band of the system may vary according to the required accuracy at the output, but as a general rule of thumb, recommended to be within 0 to plus 180 degrees within the decade below, and decade above the frequency of the frequency of the square wave to be passed.

Although this invention pertains to a loudspeaker system. The load may not necessarily be a loudspeaker, but any system which requires a frequency dividing network, and a load that requires flat phase and frequency response when their outputs are summed together.

I claim:

1. A loudspeaker system, comprising;
(a) A primary input;
(b) A frequency and phase compensating circuits to accept the primary input and generate a frequency and phase compensated first output;
(c) A linear frequency and phase dividing network which when its outputs are summed generates a flat amplitude and either a zero phase response or a constant time delay connected to the first output generating n number of outputs where n can be any number above 2;
(d) Loudspeakers attached to the outputs of the said linear frequency and phase dividing network of (c) connected to produce in phase output to that of the said linear frequency and phase dividing network of (c).

2. According to claim of 1, a loudspeaker system of 1 with additional frequency and phase compensating circuits attached between the outputs of the frequency dividing network and the loudspeakers as a means to compensate for the frequency and phase characteristics of loudspeakers.

3. According to claims of 1, or 2, a loudspeaker system of 1, or 2 with additional phase shifting or time delay circuit attached between the outputs of the frequency dividing network and loudspeakers as a means to compensate for the phase or time delay caused by the loudspeaker or the loudspeaker enclosure.

4. According to claims of 1, 2, or 3, a loudspeaker system of 1, 2, or 3 with additional power amplifiers attached before the loudspeakers, as a means to provide means of buffering the load, and amplification.

5. According to claim of 1, a loudspeaker system of 1 that combined phase shift of the loudspeaker 1(d) and their respective filter outputs of 1 (c) does not exceed the means of correcting the frequency and phase response by the compensating circuits of 1 (b).

6. According to claim of 1, a circuit of 1 where 1 (b) provides means of frequency compensation where combined frequency response of 1(b), 1(c), and 1(d) comprise a substantially flat frequency response at the output of the loudspeakers 1(d).

7. According to claim of 2, where circuit of 2 providing means of frequency compensation to loudspeakers of 1(d) to make their frequency response,
(a) substantially flat in the pass band, and
(b) substantially smooth in the stop band, and or
(c) minimize the notch in frequency in the crossover frequency region.

8. According to claim of 3, circuit of 3 where the said phase shifter provides the means that combined phase response of 1(b), 1(c), and 1(d) comprise a substantially flat phase response at the output of the loudspeakers 1(d).

9. According to claims of 1, 2, 3, 4, 5, 6, 7, and 8 in which the load 1(d) is not a loudspeaker, but some other electronic device or electromechanical transducer.

10. According to the claims of 1, 2, 3, 4, 5, 6, 7, and 8, where a loudspeaker system using one or more of 1, 2, 3, 4, 5, 6, 7, and 8 as a means to correct the frequency and the phase response of the overall system such that the combined frequency and phase response at its outputs will allow square waves to pass substantially undistorted through the system.
